(19) United States
(12) Patent Application Publication
(10) Pub. No.: US 2025/0199428 A1
(43) Pub. Date: Jun. 19, 2025

(54) TONER

(71) Applicant: CANON KABUSHIKI KAISHA, TOKYO (JP)

(72) Inventors: SHUHEI IWASAKI, KANAGAWA (JP); KENTARO YAMAWAKI, SHIZUOKA (JP); YUKI MASUDA, SHIZUOKA (JP); KENJI AOKI, SHIZUOKA (JP)

(21) Appl. No.: 18/972,282

(22) Filed: Dec. 6, 2024

(30) Foreign Application Priority Data
Dec. 13, 2023 (JP) 2023-210575

(51) Int. Cl. G03G 9/087

(52) U.S. Cl. CPC G03G 9/08793

(57) ABSTRACT

A toner comprising a toner particle comprising a binder resin, wherein the binder resin comprises a crystalline vinyl resin and an amorphous vinyl resin, the crystalline vinyl resin comprises 5.0% by mass or more of a specific monomer unit (a) having at least two alkyl groups having 16 to 30 carbon atoms, based on the mass of the crystalline vinyl resin, and the amorphous vinyl resin comprises a tetrahydrofuran insoluble matter.

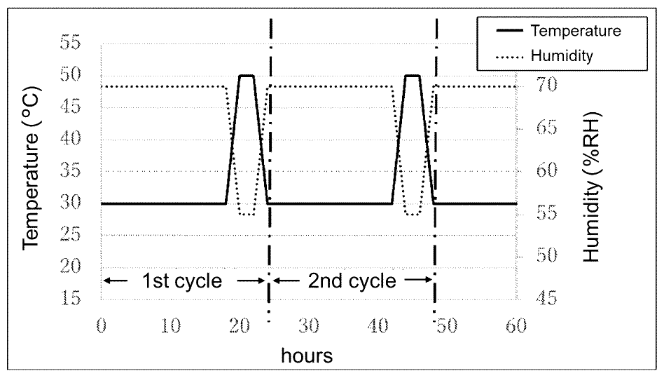

### BACKGROUND OF THE INVENTION

### Field of the Invention

The present disclosure relates to a toner for use in electrophotography and electrostatic recording.

### Description of the Related Art

A method for visualizing image information using a toner, such as electrophotography, is presently used in various fields, and there is a demand for improved performance, i.e., higher image quality as well as energy saving. In the electrophotography method, an electrostatic latent image is, first, formed on an electrophotographic photosensitive member (image carrier) through charging and exposure steps. Next, the electrostatic latent image is developed with a developer comprising a toner, and a visualized image (fixed image) is obtained through a transfer step and a fixing step.

Among these steps, the fixing step requires a relatively large amount of energy, and the development of a system and materials that make it possible to achieve both energy saving and high image quality is an important technological problem to be addressed. As an approach from the material standpoint, a technique using a crystalline resin as the binder resin of the toner is being considered. Crystalline resins have excellent heat-resistant storage stability because the molecular chains are regularly arranged and hence the resins hardly soften at temperatures lower than the melting point. Meanwhile, when the melting point is exceeded, the crystals melt rapidly, which is accompanied by a rapid drop in viscosity. For this reason, crystalline resins having excellent sharp melt property attract attention as materials that exhibit low-temperature fixability.

Main-chain crystalline resins, which are represented by crystalline polyesters and in which the main chain crystallizes, and side-chain crystalline resins, which are represented by long-chain alkyl acrylate polymers and in which the side chains crystallize, are known as crystalline resins. Among them, side-chain crystalline resins are known to exhibit excellent low-temperature fixability because the degree of crystallinity thereof is easy to increase, and such resins have been widely studied. Side-chain crystalline resins can be exemplified by crystalline vinyl resins. Crystalline vinyl resins have long-chain alkyl groups as side chains, and the long-chain alkyl groups in the side chains are oriented to each other and hence exhibit crystallinity.

Japanese Patent Application Publication No. 2020-173414 discloses a toner using a crystalline vinyl resin obtained by copolymerization of a polymerizable monomer having a long-chain alkyl group and an amorphous polymerizable monomer having a different SP value.

Meanwhile, toners using crystalline vinyl resins having long-chain alkyl groups in the side chains in the molecule have a low elastic modulus around room temperature, which causes a problem of poor durability, and toners with improved durability have been proposed.

Japanese Patent Application Publication No. 2019-219646 discloses a toner using, as a binder resin, a copolymer of a polymerizable monomer having a long-chain alkyl group, a second polymerizable monomer having a different SP value, and a composition comprising a polymerizable crosslinking agent. In addition, Japanese Patent Application Publication No. 2019-219643 discloses a toner using, as a binder resin, a kneaded mixture of a crystalline vinyl resin having a long-chain alkyl group in a side chain in the molecule and an amorphous vinyl resin to which a polymerizable crosslinking agent has been added.

In addition, Japanese Patent Application Publication No. 2021-036316 discloses a toner using, as a binder resin, a resin having a crystalline vinyl resin segment having a long-chain alkyl group and an amorphous resin segment in which a crystalline vinyl resin and a polyester resin are crosslinked with each other by a carbon-carbon bond.

### SUMMARY OF THE INVENTION

In recent years, in addition to low-temperature fixability and durability, there has been an increasing demand for storage stability against severe changes in temperature and humidity in toners. When toner bottles and cartridges are transported by sea and in a situation where temperature and humidity are not controlled, such as in dry containers, the toner bottles and cartridges may be repeatedly exposed to high and low temperature environments. For example, on routes that pass directly under the equator, the ships are exposed to an environment where a cycle, in which the temperature is around 22° C. at night and rises to around 60° C. during the day, is repeated every day. With the recent progress of global warming, it is expected that the environments to which the ships are exposed will become even harsher in the future.

Based on the results of investigations into this issue conducted by the inventors, it has been found that toners comprising crystalline resins described in prior art documents may change in gloss of fixed images after storage in an environment that simulate harsh transport environments.

The toners described in Japanese Patent Application Publication No. 2019-219646, Japanese Patent Application Publication No. 2019-219643, and Japanese Patent Application Publication No. 2021-036316 are characterized in that the crystalline resin comprises a (meth) acrylate structure having a long-chain alkyl group as a side chain and has a chemical cross-linked structure in the same main chain skeleton or the second resin skeleton. Where the structure having a long-chain alkyl group as a side chain is a (meth)acrylate structure, the distance from the surrounding long-chain alkyl groups is large, and it is considered that for this reason, the movement of the molecular chain is likely to occur due to the influence of temperature and humidity fluctuations. As a result, it is considered that where the toner is stored in a harsh transport environment, the crystalline resin is more likely to be incorporated into the cross-linked portion in the same main chain skeleton or the second resin skeleton. In view of these points, the present inventors consider that the reason why the gloss of fixed images changes after storage in an environment where significant changes in temperature and humidity occur is because the melting properties of the toner change due to a portion of the crystalline resin being incorporated into the crosslinked portion.

In view of the above, further improvements are required to realize a toner that has excellent low-temperature fixability and durability, and in which gloss fluctuation in an environment where significant changes in temperature and humidity occur can be suppressed.

The present disclosure is directed to a toner which has excellent low-temperature fixability and durability and in which gloss fluctuation after storage in an environment where significant changes in temperature and humidity occur can be suppressed.

The above object can be achieved by the following configuration.

A toner comprising a toner particle comprising a binder resin, wherein

the binder resin comprises a crystalline vinyl resin and an amorphous vinyl resin,

the crystalline vinyl resin comprises 5.0% by mass or more of a monomer unit (a) represented by a following formula (1), based on a mass of the crystalline vinyl resin:

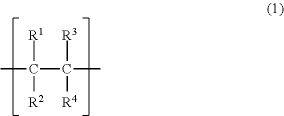

in the formula (1), at least two of R¹ to R⁴ are each independently —X—CO OR⁵, and the remaining are each independently a hydrogen atom or an alkyl group having 1to 4 carbon atoms, X is a single bond or an alkylene group having 1 or 2 carbon atoms, and R⁵ is an alkyl group having 16 to 30 carbon atoms, and

the amorphous vinyl resin comprises a tetrahydrofuran insoluble matter.

According to the present disclosure, it is possible to provide a toner that has excellent low-temperature fixability and durability in which gloss fluctuation after storage in an environment where significant changes in temperature and humidity occur repeatedly can be suppressed.

Further features of the present invention will become apparent from the following description of exemplary embodiments with reference to the attached drawings.

### BRIEF DESCRIPTION OF THE DRAWINGS

The FIGURE is a diagram of temperature and humidity changes in a heat cycle test simulating cargo ship transportation.

### DESCRIPTION OF THE EMBODIMENTS

Hereinafter, the present disclosure will be described with citing suitable embodiments.

In the present disclosure, the expression of “from XX to YY” or “XX to YY” indicating a numerical range means a numerical range including a lower limit and an upper limit which are end points, unless otherwise specified.

When a numerical range is described in a stepwise manner, the upper and lower limits of each numerical range can be arbitrarily combined. In addition, in the present disclosure, for example, descriptions such as “at least one selected from the group consisting of XX, YY and ZZ” mean any of XX, YY, ZZ, the combination of XX and YY, the combination of XX and ZZ, the combination of YY and ZZ, and the combination of XX, YY, and ZZ.

The (meth)acrylic acid ester means an acrylic acid ester and/or a methacrylic acid ester.

The “monomer unit” refers to the reacted form of a monomer substance in a polymer. For example, one carbon-carbon bond section in the main chain in the polymer in which the polymerizable monomer has been polymerized is defined as one unit. The polymerizable monomer can be represented by the following formula (A).

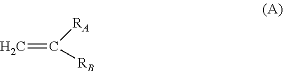

In the formula (C), R_{A} represents a hydrogen atom or an alkyl group (preferably an alkyl group having from 1 to 3 carbon atoms, and more preferably a methyl group), and R_{B} represents an arbitrary substituent.

The crystalline resin refers to a resin that shows a clear endothermic peak in differential scanning calorimetry (DSC) measurement.

As described above, it has been found that in toners comprising conventional crystalline resins, changes may occur in the gloss of fixed images after storage in an environment where significant temperature and humidity changes occur, such that simulates harsh transportation environments.

In order to solve the above problem, the inventors have conducted extensive research and have found that by using a combination of a crystalline vinyl resin having a specific monomer unit and an amorphous vinyl resin comprising a tetrahydrofuran (THF) insoluble matter as a binder resin that constitutes a toner particle, it is possible to provide a toner that has excellent low-temperature fixability and durability and can suppress gloss fluctuation after storage in an environment where significant temperature and humidity changes occur.

Namely, the toner of the present disclosure is a toner comprising a toner particle comprising a binder resin, wherein

the binder resin comprises a crystalline vinyl resin and an amorphous vinyl resin,

the crystalline vinyl resin comprises 5.0% by mass or more of a monomer unit (a) represented by a following formula (1), based on a mass of the crystalline vinyl resin:

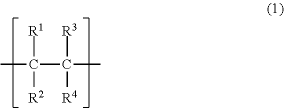

in the formula (1), at least two of R¹ to R⁴ are each independently —X—CO OR⁵, and the remaining are each independently a hydrogen atom or an alkyl group having 1to 4 carbon atoms, X is a single bond or an alkylene group having 1 or 2 carbon atoms, and R⁵ is an alkyl group having 16 to 30 carbon atoms, and the amorphous vinyl resin comprises a tetrahydrofuran insoluble matter.

The inventors believe that the mechanism by which the above technical problem can be solved with the above configuration is as follows.

As described above, in the conventional toners, the binder resin constituting the toner particle has a crosslinked portion, and the crystalline resin constituting the binder resin comprises a (meth) acrylate structure having a long-chain alkyl group as a side chain. Where the conventional toner having such a configuration is stored in an environment where significant changes in temperature and humidity occur repeatedly, the movement of the molecular chains is likely to occur, and part of the crystalline resin is likely to be incorporated into the crosslinked portion, which may cause a change in the gloss of fixed images.

In contrast, in the toner of the present disclosure, the binder resin constituting the toner particle comprises a crystalline vinyl resin and an amorphous vinyl resin, and the crystalline vinyl resin comprises a monomer unit (a) represented by the following formula (1).

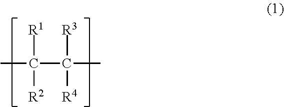

In the formula (1), at least two of R¹ to R⁴ are each independently —X—CO OR⁵, and the remaining are each independently a hydrogen atom or an alkyl group having 1to 4 carbon atoms, X is a single bond or an alkylene group having 1 or 2 carbon atoms, and R5 is an alkyl group having 16 to 30 carbon atoms.

The amorphous vinyl resin comprised in the binder resin comprises a tetrahydrofuran insoluble matter.

The fact that the amorphous vinyl resin comprises a tetrahydrofuran insoluble matter means that the amorphous vinyl resin comprises a physical crosslinked portion or a chemical crosslinked portion. The physical crosslinked portion refers to a crosslinked portion that is generated by entanglement of molecular chains of a high-molecular-weight amorphous vinyl resin. The chemical crosslinked portion refers to a crosslinked portion that is generated by adding a polyfunctional monomer. The amorphous vinyl resin comprises a tetrahydrofuran insoluble matter, which increases the elasticity of the toner and makes the toner less likely to deteriorate even with long-term use, thereby ensuring excellent durability.

Meanwhile, the crystalline vinyl resin comprises the monomer unit (a) represented by the above formula (1). As a result, the crystalline vinyl resin exhibits excellent low-temperature fixability specific to crystalline resins, and it is considered that since the long-chain alkyl groups that contribute to the development of crystallinity are close to each other, the crystal density is high and the mobility of the molecules is low.

Therefore, even in an environment where significant changes in temperature and humidity occur, the crystalline vinyl resin is less likely to be incorporated into the crosslinked portions of the amorphous vinyl resin, and changes in the melting property of the toner are less likely to occur. As a result, it is considered that it is possible to suppress gloss fluctuation of fixed images after storage in an environment where significant changes in temperature and humidity occur.

Heretofore, there have been no attempts to suppress gloss fluctuation in a harsh transportation environment where significant changes in temperature and humidity occur by such control of the crystal density by the distance between the long-chain alkyl groups that are side chains.

It is considered that the above mechanism allows the toner of the present disclosure to have excellent low-temperature fixability and durability and also makes it possible to suppress gloss fluctuation after storage in a harsh environment where significant changes in temperature and humidity occur.

The toner of the present disclosure will be described in detail below.

The toner has a toner particle.

### Toner Particle

The toner particle comprises a binder resin. The toner particles may comprise a release agent, a colorant, a charge control agent, and the like, in addition to the binder resin.

### Binder Resin

The binder resin comprises a crystalline vinyl resin and an amorphous vinyl resin.

### Crystalline Vinyl Resin

The crystalline vinyl resin comprises 5.0% by mass or more of the monomer unit (a) represented by the above formula (1) based on the mass of the crystalline vinyl resin.

Where the content ratio of the monomer unit (a) represented by the above formula (1) based on the mass of the crystalline vinyl resin (hereinafter also referred to as ratio J) is less than 5.0% by mass, gloss fluctuation after storage in an environment where significant changes in temperature and humidity occur cannot be sufficiently suppressed. Where the ratio J is 5.0% by mass or more, the resin is less likely to be incorporated into the crosslinked portions of the amorphous vinyl resin, and the gloss fluctuation of the fixed image after storage even in an environment where significant changes in temperature and humidity occur can be suppressed. Furthermore, where the ratio J is 5.0% by mass or more, excellent low-temperature fixability can be exhibited.

From the viewpoint of suppressing gloss fluctuation, the ratio J is preferably 30.0% by mass or more, and more preferably 45.0% by mass or more. In other words, it is preferable that the crystalline vinyl resin comprise 30.0% by mass or more of the monomer unit (a) based on the mass of the crystalline vinyl resin.

The upper limit of the ratio J is not particularly limited, but for example, it is preferably 5.0 to 100.0% by mass, more preferably 30.0 to 95.0% by mass, and even more preferably 45.0 to 90.0% by mass.

Furthermore, from the viewpoint of suppressing gloss fluctuation in an environment where significant changes in temperature and humidity occur, the ratio J is preferably 0.7 mol % or more. For example, the ratio J is preferably 0.7 to 40.0 mol %, more preferably 4.0 to 40.0 mol %, and even more preferably 20.0 to 35.0 mol % in terms of molar ratio. A method for introducing the monomer unit (a) into the crystalline vinyl resin will be described hereinbelow. The ratio J can be controlled by the amount of raw materials loaded when synthesizing the crystalline vinyl resin.

In the above formula (1), at least two of R¹ to R⁴ are each independently-X-COOR⁵, and the remaining are each independently a hydrogen atom or an alkyl group having 1 to 4 carbon atoms. X is a single bond or an alkylene group having 1 or 2 carbon atoms, and R⁵ is an alkyl group having 16 to 30 carbon atoms.

Where such a structure is satisfied, it is possible to ensure excellent low-temperature fixability and durability and also greatly suppress gloss fluctuation after storage in an environment where significant changes in temperature and humidity occur. Where one of R¹ to R⁴ satisfies —X—COOR⁵ and the remaining are each independently hydrogen or an alkyl group having 1 to 4 carbon atoms, gloss fluctuation after the storage test with respect to a state before the test cannot be sufficiently suppressed.

The preferred structures of the substituents are such that two of R¹ to R⁴ (more preferably one of R¹ and R² and one of R³ and R⁴) are each independently —X—COOR⁵, the remaining are each a hydrogen atom or a methyl group, X is a single bond or an alkylene group having 1 or 2 carbon atoms. It is more preferable that R⁵ be an alkyl group having 16 to 30 carbon atoms. It is also more preferable that X be a single bond.

Where R⁵ is an alkyl group having 16 to 30 carbon atoms, the crystalline vinyl resin is more likely to exhibit crystallinity, and a toner having excellent low-temperature fixability can be obtained. R⁵ is preferably an alkyl group having 18 to 28 carbon atoms, and more preferably an alkyl group having 20 to 24 carbon atoms. The alkyl group of R⁵ is preferably linear.

The binder resin preferably comprises 20.0 to 80.0% by mass of the crystalline vinyl resin based on the mass of the binder resin (the content ratio of the crystalline vinyl resin based on the mass of the binder resin is hereinafter also referred to as ratio I). Where the ratio I is in the above range, it becomes easier to achieve both low-temperature fixability and the effect of suppressing gloss fluctuation after storage in an environment where significant changes in temperature and humidity occur. The ratio I is more preferably 25.0 to 70.0% by mass, and even more preferably 30.0 to 60.0% by mass. The ratio I can be controlled by the amount of crystalline vinyl resin and the amount of other materials loaded when the toner particles are produced.

In addition to the monomer unit (a), the crystalline vinyl resin may or may not comprise a monomer unit having an alkyl group with 16 to 30 carbon atoms that is different from the monomer unit (a). In the crystalline vinyl resin, the content ratio of the monomer unit (a) among the monomer units having an alkyl group with 16 to 30carbon atoms, including the monomer unit (a) (hereinafter also referred to as ratio K), is preferably 50.0 to 100.0% by mass. The ratio K is more preferably 75.0 to 100.0% by mass, and even more preferably 90.0 to 100.0% by mass.

Where the ratio K is within the above range, the crystalline vinyl resin is less likely to be incorporated into the crosslinked portions of the amorphous vinyl resin even in an environment where significant changes in temperature and humidity occur, and the effect of suppressing gloss fluctuation after storage is further improved.

A method for introducing the monomer unit (a) represented by formula (1) into the crystalline vinyl resin is to use a polymerizable ester obtained by condensation of a polyvalent carboxylic acid having 4 to 6 carbon atoms and a carbon-carbon double bond with a monoalcohol having 16 to 30 carbon atoms and a chain-like hydrocarbon group, as a polymerizable monomer. The monomer unit (a) of formula (1) may be used alone or in combination of two or more types.

Examples of polyvalent carboxylic acids having 4 to 6 carbon atoms and a carbon-carbon double bond include maleic acid, fumaric acid, citraconic acid, mesaconic acid, itaconic acid, glutaconic acid, trans-aconitic acid, cis-aconitic acid, and the like. Furthermore, acid anhydrides and lower alkyl (1 to 4 carbon atoms) esters (for example, methyl ester, ethyl ester, isopropyl ester, and the like) of these polyvalent carboxylic acids may be used. The polyvalent carboxylic acids may be used alone or in combination of two or more. Among these, from the viewpoint of suppressing gloss fluctuation after storage in an environment where significant changes in temperature and humidity occur, at least one selected from the group consisting of maleic acid, fumaric acid, itaconic acid, and acid anhydrides thereof is preferred.

Examples of monoalcohols having 16 to 30 carbon atoms and a chain hydrocarbon group include alcohols having a linear alkyl group (alkyl group having 16 to 30 carbon atoms) (cetanol, stearyl alcohol, 1-eicosanol, behenyl alcohol, 1-tetracosanol, 1-triacontanol, and the like) and alcohols having a branched alkyl group (alkyl group having 16 to 30 carbon atoms) (2-decyl-1-tetradecanol, and the like). Among these, from the viewpoint of crystallinity, alcohols having a linear alkyl group (alkyl group having 16 to 30 carbon atoms) are preferred. More preferred are alcohols having a linear alkyl group (alkyl group having 18 to 28 carbon atoms), and even more preferred are alcohols having a linear alkyl group (alkyl group having 20 to 24 carbon atoms).

A method for producing the polymerizable ester is not particularly limited, provided that a polyvalent carboxylic acid having 4 to 6 carbon atoms and a carbon-carbon double bond is condensed with a monoalcohol having 16 to 30 carbon atoms and a chain hydrocarbon group. It is preferable to use an esterification catalyst or a stabilizer (polymerization inhibitor) to carry out reliable condensation reaction and to prevent the reaction of the carbon-carbon double bond during the production of the polymerizable ester.

The crystalline vinyl resin preferably comprises a monomer unit corresponding to methacrylonitrile. The crystalline vinyl resin preferably comprises 1.0 to 25.0% by mass, and more preferably 10.0 to 20.0% by mass of a monomer unit corresponding to methacrylonitrile.

Furthermore, the crystalline vinyl resin preferably comprises a monomer unit corresponding to styrene. The crystalline vinyl resin preferably comprises 1.0 to 60.0% by mass of and more preferably 4.0 to 10.0% by mass a monomer unit corresponding to styrene.

The acid value of the crystalline vinyl resin is preferably 3.0 mg KOH/g or less from the viewpoints of improving low-temperature fixability determined by the development of crystallinity and suppressing gloss fluctuation after storage in an environment where significant changes in temperature and humidity occur.

The acid value of the crystalline vinyl resin is more preferably from 0.0 to 2.0 mg KOH/g, and even more preferably 0.1 to 1.0 mg KOH/g. An acid value of 3.0 mg KOH/g or less indicates that there are few unreacted segments when synthesizing the crystalline vinyl resin. That is, it is considered that the crystal density is high because there are few segments to which the monoalcohol is not attached. The acid value can be controlled within the above range by controlling the ratio of carboxylic acid to alcohol when synthesizing the crystalline resin.

The crystalline vinyl resin may comprise other monomer units in addition to the monomer unit (a) represented by formula (1). One method for introducing other monomer units is to polymerize the above polymerizable ester with other vinyl monomers.

Examples of other vinyl monomers include the following.

Styrene, α-methylstyrene, and (meth)acrylic acid esters such as methyl (meth)acrylate, ethyl (meth)acrylate, n-butyl (meth)acrylate, t-butyl (meth)acrylate, and 2-ethylhexyl (meth)acrylate.

Monomers having a urea group: for example, monomers obtained by reacting an amine having 3 to 22 carbon atoms [primary amines (such as normal butylamine, t-butylamine, propylamine, and isopropylamine), secondary amines (such as di-normal ethylamine, di-normal propylamine, and di-normal butylamine), aniline, cycloxylamine, and the like] with an isocyanate having 2 to 30 carbon atoms and an ethylenically unsaturated bond by a known method.

Monomers having a carboxy group: for example, methacrylic acid, acrylic acid, and 2-carboxyethyl (meth)acrylate, and the like.

Monomers having a hydroxy group: for example, 2-hydroxyethyl (meth)acrylate, 2-hydroxypropyl (meth)acrylate, and the like.

Monomers having an amide group: for example, acrylamide, and monomers obtained by reacting an amine having 1 to 30 carbon atoms with a carboxylic acid having 2 to 30 carbon atoms and an ethylenically unsaturated bond (such as acrylic acid and methacrylic acid) by a known method, and the like. Monomers having a lactam structure; for example, N-vinyl-2-pyrrolidone, and the like.

Among these, it is preferred that the crystalline vinyl resin comprise, in addition to the monomer unit (a), a monomer unit (b) different from the monomer unit (a).

Where the SP value of the monomer unit (a) is SPa (J/cm³)^{0.5} and the SP value of the monomer unit (b) is SPb (J/cm³)^{0.5}, it is preferred that the Spa and the SPb satisfy following formula (2).

However, where there are two or more types of other monomer units used in addition to the monomer unit (a) represented by formula (1), among these additional monomer units, the monomer unit that has a largest difference in SP value with the monomer unit (a) is selected as the monomer unit (b).

$$3. \leq \vert SPb - SPa \vert \leq 21. \qquad ( 2 )$$

Where the relationship between the SP value SPa of the monomer unit (a) and the SP value SPb of the monomer unit (b) is within the above range, the crystalline segments and amorphous segments in the crystalline vinyl resin tend to form a clear phase separation state, so that appropriate crystallinity can be maintained.

Furthermore, it is more preferable that the relationship between the SP value SPa of the monomer unit (a) and the SP value SPb of the monomer unit (b) satisfy formula (3).

$$7. \leq \vert SPb - SPa \vert \leq 12.0 \qquad ( 3 )$$

SPa (J/cm³)^{0.5} is preferably 15.0 to 21.0, and more preferably 16.0 to 18.5. SPb (J/cm³)^{0.5} is preferably 20.0 to 40.0, and more preferably 25.0 to 30.0. It is also preferable that SPb≥Spa.

The crystalline vinyl resin may be produced by any known method within the scope of the configuration of the present application, but it is preferable that the composition of polymerizable monomers comprising the above-mentioned polymerizable ester be polymerized using an initiator or the like.

A known polymerization initiator can be used as the polymerization initiator.

Examples of the polymerization initiator include azo-based or diazo-based polymerization initiators such as 2,2′-azobis-(2,4-dimethylvaleronitrile), 2,2′-azobisisobutyronitrile, 1,1′-azobis (cyclohexane-1-carbonitrile), 2,2′-azobis-4-methoxy-2,4-dimethylvaleronitrile, azobisisobutyronitrile, and the like; peroxide-based polymerization initiators such as benzoyl peroxide, t-butylperoxy 2-ethylhexanoate, t-butylperoxypivalate, t-butylperoxyisobutyrate, t-butylperoxyneodecanoate, methyl ethyl ketone peroxide, diisopropyl peroxycarbonate, cumene hydroperoxide, 2,4-dichlorobenzoyl peroxide, lauroyl peroxide, and the like.

In addition, a known chain transfer agent or polymerization inhibitor may also be used.

### Amorphous Vinyl Resin

The binder resin comprises an amorphous vinyl resin. The amorphous vinyl resin comprises a tetrahydrofuran insoluble matter. The amorphous vinyl resin is preferably a synthetic resin with a main chain bonded by vinyl polymerization.

Examples of polymerizable monomers used in amorphous vinyl resins include styrene derivatives such as a-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene; (meth)acrylic acid esters such as methyl (meth)acrylate, ethyl (meth)acrylate, butyl (meth)acrylates (n-butyl (meth)acrylate, t-butyl (meth)acrylate, and the like), and 2-ethylhexyl (meth)acrylate; and acrylonitrile, methacrylonitrile, (meth) acrylic acid, and the like.

The amorphous vinyl resin (B) is preferably a polymer of a monomer mixture comprising styrene and butyl (meth) acrylate.

The content ratio of the amorphous vinyl resin based on the mass of the binder resin is not particularly limited and is preferably 1.0 to 80.0% by mass, and more preferably 5.0 to 70.0% by mass.

The binder resin preferably comprises 2.0 to 50.0% by mass of a tetrahydrofuran insoluble matter based on the mass of the binder resin. Hereinafter, the content ratio of the tetrahydrofuran insoluble matter in the binder resin is also referred to as ratio L.

The ratio L is more preferably 5.0 to 40.0% by mass, and even more preferably 10.0 to 30.0% by mass. By setting the ratio L within the above range, both excellent low-temperature fixability and durability can be achieved.

The crystalline vinyl resin preferably comprises 5.0 to 100.0% by mass of the tetrahydrofuran insoluble matter based on the mass of the crystalline vinyl resin. Hereinafter, the content ratio of the tetrahydrofuran insoluble matter in the crystalline vinyl resin is also referred to as ratio M.

The ratio M is more preferably 10.0 to 95.0% by mass, and even more preferably 20.0 to 90.0% by mass.

Where the content of the tetrahydrofuran insoluble matter is within the above range, it becomes easier to achieve low-temperature fixability, durability, and the effect of suppressing gloss fluctuation after storage in an environment where significant changes in temperature and humidity occur.

The tetrahydrofuran insoluble matter of the amorphous vinyl resin may be formed by entanglement of molecular chains of the high-molecular-weight amorphous vinyl resin, i.e., by physical crosslinking, or may be formed by chemical crosslinking obtained by adding a multifunctional monomer such as a crosslinking agent. The amorphous vinyl resin is a polymer of a composition comprising polymerizable monomers and a crosslinking agent, and it is preferable that the crosslinking agent have two or more polymerizable double bonds. Where the amorphous vinyl resin has the above configuration, it is possible to achieve excellent durability and also to suppress gloss fluctuation in an environment where significant changes in temperature and humidity occur.

As a crosslinking agent having two or more polymerizable double bonds, the following are preferably used.

Aromatic divinyl compounds (divinylbenzene, divinylnaphthalene); diacrylate compounds linked with alkyl chains (ethylene glycol diacrylate, 1,3-butylene glycol diacrylate, 1,4-butanediol diacrylate, 1,5-pentanediol acrylate, 1,6-hexanediol diacrylate, neopentyl glycol diacrylate, and compounds in which these acrylates are replaced with methacrylates); diacrylate compounds linked with alkyl chains comprising ether bonds (for example, diethylene glycol diacrylate, triethylene glycol diacrylate, tetraethylene glycol diacrylate, polyethylene glycol #400 diacrylate, polyethylene glycol #600 diacrylate, dipropylene glycol diacrylate, and compounds in which these acrylates are replaced with methacrylates); diacrylate compounds linked by chains comprising aromatic groups and ether bonds [polyoxyethylene (2)-2,2-bis(4-hydroxyphenyl) propane diacrylate, polyoxyethylene (4)-2,2-bis(4-hydroxyphenyl) propane diacrylate, and compounds in which these acrylates are replaced with methacrylates]; polyester-type diacrylate compounds, and the like.

Examples of polyfunctional crosslinking agents include the following: pentaerythritol triacrylate, trimethylolethane triacrylate, trimethylolpropane triacrylate, tetramethylolmethane tetraacrylate, oligoester acrylate, and compounds in which these acrylates are replaced with methacrylates; triallyl cyanurate, triallyl trimellitate, and the like.

Among these crosslinking agents, aromatic divinyl compounds (particularly divinylbenzene) and diacrylate compounds linked by chains comprising an aromatic group and an ether bond are preferred, and diacrylate compounds linked by chains comprising an aromatic group and an ether bond are more preferred. As a crosslinking agent, for example, 1,6-hexanediol diacrylate is preferred.

The crosslinking agent can be used in an amount of preferably 0.01 to 10.00 parts by mass, more preferably 0.03 to 5.00 parts by mass per 100 parts by mass of the polymerizable monomer components other than the crosslinking agent.

It is preferred that the amorphous vinyl resin does not comprise the monomer unit (a) represented by formula (1).

### Release Agent

The toner particle may comprise a release agent. The release agent is preferably at least one selected from the group consisting of hydrocarbon waxes and ester waxes. By using a hydrocarbon wax and/or an ester wax, effective release properties can be easily ensured.

There are no particular limitations on the hydrocarbon wax, but examples include the following.

Aliphatic hydrocarbon waxes: low-molecular-weight polyethylene, low-molecular-weight polypropylene, low-molecular-weight olefin copolymer, Fischer-Tropsch wax, or waxes obtained by oxidizing these or adding an acid thereto.

The ester wax may have at least one ester bond in one molecule and may be either a natural ester wax or a synthetic ester wax.

There are no particular limitations on the ester wax, and examples thereof include the following:
esters of monohydric alcohols and monocarboxylic acids, such as behenyl behenate, stearyl stearate, and palmityl palmitate;
esters of dihydric carboxylic acids and monoalcohols, such as dibehenyl sebacate;
esters of dihydric alcohols and monocarboxylic acids, such as ethylene glycol distearate and hexanediol dibehenate;
esters of trihydric alcohols and monocarboxylic acids, such as glycerin tribehenate;
esters of tetrahydric alcohols and monocarboxylic acids, such as pentaerythritol tetrastearate and pentaerythritol tetrapalmitate;
esters of hexahydric alcohols and monocarboxylic acids, such as dipentaerythritol hexastearate, dipentaerythritol hexapalmitate, and dipentaerythritol hexabehenate;
esters of polyfunctional alcohols and monocarboxylic acids, such as polyglycerin behenate; and
natural ester waxes, such as carnauba wax and rice wax.

Among these, esters of hexahydric alcohols and monocarboxylic acids, such as dipentaerythritol hexastearate, dipentaerythritol hexapalmitate, and dipentaerythritol hexabehenate, and esters of octahydric alcohols and monocarboxylic acids, such as tripentaerythritol hexastearate, tripentaerythritol hexapalmitate, and tripentaerythritol hexabehenate, are preferred.

In the toner, the content of the release agent in the toner particle is preferably 1.0 to 30.0% by mass, and more preferably 2.0 to 25.0% by mass. Where the content of the release agent in the toner particle is within the above range, releasability during fixing is easily ensured.

The melting point of the release agent is preferably 60 to 120° C. Where the melting point of the release agent is within the above range, the release agent melts during fixing and easily out-migrates to the surface of the toner particle, making it easier to exhibit releasability. The melting point of the release agent is more preferably 70 to 100° C.

### Colorant

The toner particle may comprise a colorant. Examples of colorants include known organic pigments, organic dyes, inorganic pigments, carbon black as a black colorant, magnetic particles, and the like. In addition, colorants that have been used in conventional toners may be used.

Examples of yellow colorants include the following. Condensed azo compounds, isoindolinone compounds, anthraquinone compounds, azo metal complexes, methine compounds, and allylamide compounds and the like. Specifically, C. I. Pigment Yellow 12, 13, 14, 15, 17, 62, 74, 83, 93, 94, 95, 109, 110, 111, 128, 129, 147, 155, 168, 180 are suitable.

Examples of magenta colorants include the following. Condensation azo compounds, diketopyrrolopyrrole compounds, anthraquinone compounds, quinacridone compounds, basic dye lake compounds, naphthol compounds, benzimidazolone compounds, thioindigo compounds, perylene compounds and the like. Specifically, C. I. Pigment Red 2, 3, 5, 6, 7, 23, 48:2, 48:3, 48:4, 57:1, 81:1, 122, 144, 146, 166, 169, 177, 184, 185, 202, 206, 220, 221, 254 are suitable.

Examples of cyan colorants include the following. copper phthalocyanine compounds and derivatives thereof, anthraquinone compounds, basic dye lake compound and the like. Specifically, C. I. Pigment Blue 1, 7, 15, 15:1, 15:2, 15:3, 15:4, 60, 62, 66 are suitable.

Colorants are selected for their hue angle, saturation, brightness, lightfastness, OHP transparency, and dispersibility in the toner.

The content of the colorant is preferably 1.0 to 20.0 parts by mass per 100.0 parts by mass of the binder resin. Where magnetic particles are used as the colorant, the content is preferably 40.0 to 150.0 parts by mass per 100.0 parts by mass of the binder resin.

### Charge Control Agent

The toner particle may comprise a charge control agent as necessary. In addition, the charge control agent may be added externally to the toner particle. By blending the charge control agent, the charge characteristics can be stabilized, and it becomes possible to control the optimal friction charge quantity according to the development system.

As the charge control agent, a known charge control agent can be used, and a charge control agent that has a particularly fast charging speed and can stably maintain a constant charge quantity is preferable.

Examples of charge control agents that control the toner to negative chargeability include the following.

Organometallic compounds and chelating compounds are effective, and examples thereof include monoazo metallic compounds, acetylacetone metallic compounds, aromatic hydroxycarboxylic acids, aromatic dicarboxylic acids, and hydroxycarboxylic acid and dicarboxylic acid-based metallic compounds.

Examples of charge control agents that control the toner to positive chargeability include the following.

Nigrosine, quaternary ammonium salts, metallic salts of higher fatty acids, diorganotin borates, guanidine compounds, and imidazole compounds.

The content of the charge control agent is preferably 0.01 to 20.0 parts by mass, and more preferably 0.5 to 10.0 parts by mass with respect to 100.0 parts by mass of the toner particles.

### Production Method of Toner Particle

A production method of toner particle is not particularly limited, and any known method such as suspension polymerization method, emulsion aggregation method, dissolution suspension method, and pulverization method may be adopted, but it is preferable that the toner particle be produced by the suspension polymerization method. It is preferable that the toner particle be a suspension-polymerized toner particle.

The suspension polymerization method will be described in detail.

For example, the crystalline vinyl resin synthesized in advance is added to a mixture of polymerizable monomers that produces, for example, an amorphous vinyl resin. If necessary, other materials such as a colorant, a release agent, and a charge control agent are added and uniformly dissolved or dispersed to prepare a polymerizable monomer composition.

Then, the polymerizable monomer composition is dispersed in an aqueous medium using a stirrer or the like to prepare suspended particles of the polymerizable monomer composition. The polymerizable monomers comprised in the particles are then polymerized using an initiator or the like to obtain toner particles.

After completion of polymerization, the toner particles can be filtered, washed, and dried by known methods. If necessary, an external additive or the like may be added to obtain the toner.

A known polymerization initiator can be used as the polymerization initiator.

Examples of the polymerization initiator include azo or diazo polymerization initiators such as 2,2′-azobis-(2,4-dimethylvaleronitrile), 2,2′-azobisisobutyronitrile, 1,1′-azobis (cyclohexane-1-carbonitrile), 2,2′-azobis-4-methoxy-2,4-dimethylvaleronitrile, and azobisisobutyronitrile; and peroxide polymerization initiators such as benzoyl peroxide, t-butyl peroxy-2-ethylhexanoate, t-butyl peroxypivalate, t-butyl peroxyisobutyrate, t-butyl peroxyneodecanoate, methyl ethyl ketone peroxide, diisopropyl peroxycarbonate, cumene hydroperoxide, 2,4-dichlorobenzoyl peroxide, and lauroyl peroxide.

Furthermore, known chain transfer agents and polymerization inhibitors may be used.

The aqueous medium may comprise an inorganic or organic dispersion stabilizer. Known dispersion stabilizers can be used as the dispersion stabilizer.

Examples of inorganic dispersion stabilizers include phosphates such as hydroxyapatite, tricalcium phosphate, dicalcium phosphate, magnesium phosphate, aluminum phosphate, and zinc phosphate; carbonates such as calcium carbonate and magnesium carbonate; metal hydroxides such as calcium hydroxide, magnesium hydroxide, and aluminum hydroxide; sulfates such as calcium sulfate and barium sulfate; calcium metasilicate; bentonite; silica; alumina, and the like.

Meanwhile, examples of organic dispersion stabilizers include polyvinyl alcohol, gelatin, methyl cellulose, methylhydroxypropyl cellulose, ethyl cellulose, sodium salt of carboxymethyl cellulose, polyacrylic acid and salts thereof, starch, and the like.

Where an inorganic compound is used as a dispersion stabilizer, a commercially available product may be used as is, but in order to obtain finer particles, the inorganic compound formed in an aqueous medium may be used.

For example, in the case of calcium phosphate such as hydroxyapatite or tricalcium phosphate, an aqueous phosphate solution and an aqueous calcium salt solution may be mixed under high agitation.

The aqueous medium may comprise a surfactant. As the surfactant, a known surfactant may be used. For example, anionic surfactants such as sodium dodecylbenzene sulfate and sodium oleate; cationic surfactants; amphoteric surfactants; nonionic surfactants, and the like may be mentioned.

### External Additive

The toner particles may be used as a toner as is or may be made into a toner by mixing with an external additive and the like, as necessary, and attaching the external additive to the surface of the toner particle.

Examples of external additives include inorganic fine particles selected from the group consisting of silica fine particles, alumina fine particles, and titania fine particles, or composite oxides thereof. For example, composite oxides include silica aluminum fine particles and strontium titanate fine particles.

The content of the external additive is preferably 0.01 to 8.0 parts by mass, and more preferably 0.1 to 4.0 parts by mass, per 100 parts by mass of the toner particles.

The calculation and measurement methods for various physical properties of the toner and toner materials are described below.

### Measurement Method of Differential Scanning calorimetry (DSC)

The endothermic peak temperature and exothermic peak temperature of crystalline resin and release agent are measured in accordance with ASTM D3418-82 using a differential scanning calorimetry analyzer “Q1000” (manufactured by TA Instruments). The melting points of indium and zinc are used for temperature correction of the device detection unit, and the heat of fusion of indium is used for heat correction.

The toner measurement is performed by, first, accurately weighing 10 mg of toner and placing it in an aluminum pan, and using an empty aluminum pan as a reference. In the first temperature raising process, the temperature of the measurement sample is raised from 20° C. to 180° C. at 10° C./min while the measurement is performed, and differential scanning calorimetry curve A is obtained. After that, the material is held at 180° C. for 10 min, and then a cooling process is performed in which the material is cooled from 180° C. to 10° C. at 10° C./min while the measurement is performed to obtain a differential scanning calorimetric curve B. After that, the material is held at 10° C. for 10 min, and then in the second temperature raising process, the temperature is raised again from 10° C. to 180° C. at 10° C./min while the measurement is performed to obtain a differential scanning calorimetric curve C. The peak top temperature of the peak that appears in the obtained differential scanning calorimetric curve C is determined and is taken as the peak temperature.

### Method for Separating Toner Particle from Toner

When analyzing toner particle, where the surface of the toner particle is treated with an external additive or the like, the external additive is separated by the following method to obtain the toner particle.

A total of 160 g of sucrose (manufactured by Kishida Chemical Co., Ltd.) is added to 100 mL of ion-exchanged water and dissolved while heating in a hot water bath to prepare a concentrated sucrose solution. A total of 31 g of the concentrated sucrose solution and 6 mL of Contaminon N (a 10% by mass aqueous solution of a neutral detergent for cleaning precision measuring instruments with a pH of 7 consisting of a nonionic surfactant, an anionic surfactant, and an organic builder, manufactured by Wako Pure Chemical Industries, Ltd.) is placed in a centrifuge tube to prepare a dispersion liquid.

Then, 1.0 g of toner is added to this dispersion liquid and the toner lumps are broken up with a spatula or the like. The centrifuge tube is shaken at 350 spm (strokes per minute) for 20 min in a shaker (AS-IN, marketed by AS ONE Corporation). After shaking, the solution is transferred to a glass tube (50 mL) for a swing rotor, and separation is performed in a centrifuge (H-9R, manufactured by KOKUSAN Co., Ltd.) at 3,500 rpm for 30 min. This operation separates the toner particles from the external additive that has been removed.

Sufficient separation of the toner particles and the aqueous solution is visually confirmed, and the toner particles that have separated to the top layer are collected with a spatula or the like. The collected toner is filtered with a vacuum filter and then dried in a dryer for at least 1 h to obtain toner particles. This operation is carried out multiple times to ensure the required amount.

### Method for Separating Tetrahydrofuran (THF) Insoluble Matter

A total of 1.5 g of toner particles from which a THF insoluble matter is to be separated is accurately weighed (W [g]) (0.7 g when measuring the THF insoluble matter of the resin alone) and placed in a pre-weighed cylindrical filter paper (product name: No. 86R, size 28×100 mm, manufactured by Advantec Toyo Co., Ltd.) which is then set in a Soxhlet extractor.

Extraction is performed for 18 h using 200 mL of tetrahydrofuran (THF) as a solvent. At this time, the extraction is performed at a reflux rate such that the solvent extraction cycle occurs once every 5 min.

After the extraction is complete, the cylindrical filter paper is removed, air-dried, and then vacuum-dried at 40° C. for 8 h to obtain the extraction residue. The mass of the cylindrical filter paper including the extraction residue is weighed, and the mass of the extraction residue (W2 [g]) is calculated by subtracting the mass of the cylindrical filter paper. Meanwhile, the THF soluble matter is obtained by thoroughly distilling off the THF from the THF soluble matter using an evaporator. The mass of the resulting THF soluble matter is designated as W1 [g].

Next, the mass of components other than resin in the extraction residue is calculated using the following procedure. The THF extraction residue (W2 [g]) is placed into a pre-weighed 30 ml porcelain crucible. The crucible is placed in an electric furnace, heated at 900° C. for 3 h, allowed to cool in the electric furnace, and then allowed to cool in a desiccator at room temperature for at least 1 h. After cooling, the mass of the crucible comprising the incineration ash is weighed, and the mass of the incineration ash (W22 [g]) is calculated by subtracting the mass of the crucible. Here, the incineration ash is the component other than resin in the extraction residue. In other words, W22 [g] is the mass of the components other than resin in the extraction residue.

Then, the mass of the resin component comprised in the extraction residue (W2 [g]) is calculated using the following formula (9). This is the mass of the THF insoluble matter (W21 [g]).

$$W 21 = W 2 - W 22 \qquad ( 9 )$$

The recovered THF insoluble matter is subjected to DSC measurement using the above method, and in the case where no melting point peak is present, it can be determined that the THF insoluble matter is an amorphous resin. Furthermore, the components of the THF insoluble matter can be analyzed by combining well-known methods such as Fourier transform infrared spectroscopy and pyrolysis gas chromatography to analyze the THF insoluble matter.

### Method for Separating Crystalline Vinyl Resin and Amorphous Vinyl Resin from Toner Particle

Separation of crystalline vinyl resin and amorphous vinyl resin from the toner particle can be achieved by known methods, an example of which is shown below.

Gradient LC is used as a method for separating resin components from toner particles. In this analysis, separation can be achieved according to the polarity of the resin in the binder resin, regardless of molecular weight.

In the present invention, since the toner particle comprises a THF insoluble matter, the separation into a THF insoluble matter and a THF soluble matter is performed according to the above-mentioned <Method for Separating Tetrahydrofuran (THF) Insoluble Matter>.

Next, the THF soluble matter is dissolved in chloroform. The sample concentration is adjusted to 0.1% by mass in chloroform, and the solution is filtered through a 0.45 μm PTFE filter and used for measurement. The gradient polymer LC measurement conditions are shown below.
Apparatus: UltiMate 3000 (manufactured by Thermo-Fisher-Scientific Inc.)
Mobile phase: A chloroform (HPLC), B acetonitrile (HPLC)
Gradient: 2 min (A/B=0/100)→25 min (A/B=100/0)
(The gradient of the mobile phase change was set to be linear.)
Flow rate: 1.0 mL/min
Injection: 0.1% by mass × 20 μL
Column: Tosoh TSKgel ODS (4.6 mm diameter×150 mm×5 μm)
Column temperature: 40° C.
Detector: Corona Charged Aerosol Detector (Corona-CAD) (manufactured by Thermo-Fisher-Scientific Inc.)

The resin components can be separated into two peaks according to polarity in the time-intensity graph obtained by the measurement. After that, the above measurement is performed again, and separation into two types of resin can be performed by taking out the fractions at the time when the valleys of the respective peaks are reached. The separated resins are subjected to DSC measurement, and the resin with a melting point peak is taken as the crystalline vinyl resin (mass W11 [g]), and the resin without a melting point peak is taken as the amorphous vinyl resin (mass W12 [g]).

Where the toner particle comprises a release agent, it is necessary to separate the release agent from the toner particle in advance. In the separation of the release agent, the components with a molecular weight of 3000 or less are separated by recycling HPLC as the release agent. The molecular weight at the time of separation can be changed according to the molecular weight of the release agent. The measurement method is described hereinbelow.

First, a chloroform solution of the toner is prepared using the method described above. The resulting solution is then filtered through a solvent-resistant membrane filter “MyShori Disc” (manufactured by Tosoh Corporation) with a pore size of 0.2 μm to obtain a sample solution. The sample solution is adjusted so that the concentration of components soluble in chloroform is 1.0% by mass. This sample solution is used for measurements under the following conditions.
Apparatus: LC-Sakura-NEXT (manufactured by Japan Analytical Industry Co., Ltd.)
Column: JAIGEL 2H, 4H (manufactured by Japan Analytical Industry Co., Ltd.)
Eluent: Chloroform
Flow rate: 10.0 ml/min
Oven temperature: 40.0° C.
Sample injection amount: 1.0 ml

To calculate the molecular weight of the sample, a molecular weight calibration curve is prepared using standard polystyrene resins (product names “TSK Standard Polystyrene F-850, F-450, F-288, F-128, F-80, F-40, F-20, F-10, F-4, F-2, F-1, A-5000, A-2500, A-1000 and A-500”, produced by Tosoh Corporation).

From the molecular weight curve thus obtained, components with a molecular weight of 3000 or less are repeatedly fractionated, and the release agent (mass W3 [g]) is removed from the toner particle.

### Measurement of Content Ratio of Each Component in Toner Particle

The content ratio of each component in the toner particle is calculated in the following manner from the masses described in the above-mentioned <Method for Separating Tetrahydrofuran (THF) Insoluble Matter> and <Method for Separating Crystalline Vinyl Resin and Amorphous Vinyl Resin from Toner Particle>.

### [Mass Ratio of Crystalline Vinyl Resin Based on the Mass of Binder Resin: Ratio I (Unit: % By Mass)]

$$Ratio I = ( W 11 / ( W 11 + W 12 + W 21 - W 3 ) ) \times 100 \qquad ( 4 )$$

### [Mass Ratio of THF Insoluble Matter Based on the Mass of Binder Resin: Ratio L (Unit: % By Mass)]

$$Ratio L = ( W 2 / ( W 11 + W 12 + W 21 - W 3 ) ) \times 100 \qquad ( 5 )$$

### [Mass Ratio of THF Insoluble Matter Based on the Mass of Crystalline Vinyl Resin: Ratio M (Unit: % by Mass)]

$$Ratio M = ( W 21 / W 11 ) \times 100 \qquad ( 6 )$$

### Method for Measuring Content Ratio of Various Monomer Units Such as Monomer Unit (a) in Resin and the Number of Carbon Atoms in Alkyl Groups

The content ratio of various monomer units such as the monomer unit (a) in the resin and the number of carbon atoms in alkyl groups are measured by ¹H-NMR under the following conditions. The crystalline vinyl resin separated using the above method can be used as the measurement sample.
Measurement device: FT NMR device JNM-EX400 (manufactured by JEOL Ltd.)
Measurement frequency: 400 MHZ
Pulse condition: 5.0 μs
Frequency range: 10,500 Hz
Number of times of accumulation: 64
Measurement temperature: 30° C.

Sample: the sample is prepared by placing 50 mg of the measurement sample in a sample tube with an inner diameter of 5 mm, adding deuterated chloroform (CDCl₃) as a solvent, and dissolving the measurement sample in a thermostatic bath at 40° C. The obtained ¹H-NMR chart is analyzed to identify the structure of each monomer unit. As an example, the measurement of the content ratio of the monomer unit (a) in the crystalline vinyl resin and the number of carbon atoms of the alkyl groups is described herein. In the obtained ¹H-NMR chart, a peak that is independent of the peaks attributed to components of other monomer units is selected from the peaks that are attributed to the components of the monomer unit (a), and the integral value S1 of this peak is calculated. The integral values of the other monomer units comprised in the crystalline vinyl resin are calculated in the same manner.

For example, where the monomer units constituting the crystalline vinyl resin are the monomer unit (a) and one other monomer unit, the content ratio of the monomer unit (a) is calculated as follows using the integral value S1 and the integral value S2 of the peak of the other monomer unit. Here, n1 and n2 are the numbers of hydrogen atoms in the components to which the peaks of interest for each segment belong.

$$Content ratio of the monomer unit ( a ) ( mol \% ) = \{ ( S 1 / n 1 ) / ( ( S 1 / n 1 ) + ( S 2 / n 2 ) ) \} \times 100$$

When there are two or more other monomer units, the content ratio of the monomer unit (a) can be also calculated in the same manner (using S3 . . . Sx, n3 . . . nx).

The number of carbon atoms in the alkyl group can be calculated from the integral ratio of proton peaks in the ¹H-NMR chart.

When a polymerizable monomer that does not comprise hydrogen atoms in components other than the vinyl group is used, the measurement nucleus is set to ¹³C using ¹³C-NMR, measurement is performed in a single pulse mode, and calculation is performed in the same manner as in ¹H-NMR.

The proportion (mol %) of each monomer unit calculated by the above method is multiplied by the molecular weight of each monomer unit to convert the content ratio of each monomer unit to “% by mass”. In this way, the content ratio (ratio J) of the monomer unit (a) in the crystalline vinyl resin based on the mass of the crystalline vinyl resin is calculated.

### [Content Ratio of Monomer Unit (a) Based on the Mass of Crystalline Vinyl Resin (A): Ratio J (Unit: % by Mass)]

$$J = \{ ( S 1 / n 1 ) \times M 1 / ( ( S 1 / n 1 ) \times M 1 + ( S 2 / n 2 ) \times M 2 ) \} \times 100 \qquad ( 7 )$$

In addition, where a unit having an alkyl group with 16 to 30 carbon atoms is present in addition to the monomer unit (a), the content ratio (ratio K) of the monomer unit (a) in the monomer units having an alkyl group with 16 to 30 carbon atoms is calculated as follows. For example, where the units having an alkyl group with 16 to 30 carbon atoms are the monomer unit (a) and one other monomer unit, the content ratio of the monomer unit (a) is calculated by the following formula using the integral value S1 and the integral value S3 of the peak of the other monomer unit.

[Mass Ratio of Monomer Unit (a) in Units Having an Alkyl Group with 16 to 30 Carbon Atoms: Ratio K (Unit: % by Mass)]

$$Ratio K = \{ ( S 1 / n 1 ) \times M 1 / ( ( S 1 / n 1 ) \times M 1 \times ( S 3 / n 3 ) \times M 3 ) \} \times 100 \qquad ( 8 )$$

Here, M1 and M3 are the molecular weights of the respective monomer units. The same method is used to perform measurement for the amorphous vinyl resins.

### Method for Calculating Solubility Parameters (SP Values)

The SP values (SPa, SPb) of the monomer unit are calculated as follows according to the calculation method proposed by Fedors.

First, the SP values of the monomer units that constitute the resin are calculated in the following manner. Here, the monomer unit that constitutes the resin refers to the molecular structure in the state in which the double bond of the monomer used when obtaining the resin by polymerization is cleaved by polymerization.

For example, when calculating the SP value (om) (J/cm³)^{0.5} of a monomer unit, the evaporation energy (Δei) (cal/mol) and molar volume (Δvi) (cm³/mol) for the atom or atomic group in the molecular structure of the monomer unit are obtained from the table in “Polym. Eng. Sci., 14(2), 147-154 (1974)”, and (4.184×ΣΔei/ΣΔvi)^{0.5} is taken as the SP value (J/cm³)^{0.5}.

### Method for Measuring Acid Value

Acid value is the number of milligrams of potassium hydroxide required to neutralize an acid comprised in 1 g of sample. The acid value of resin is measured according to JIS K 0070-1992, specifically, according to the following procedure.
(1) Preparation of Reagents

A total of 1.0 g of phenolphthalein is dissolved in 90 mL of ethyl alcohol (95% by volume), and ion-exchanged water is added to make 100 mL and obtain a phenolphthalein solution.

A total of 7 g of special grade potassium hydroxide is dissolved in 5 mL of water, and ethyl alcohol (95% by volume) is added to make 1 L. The solution is placed in an alkali-resistant container to avoid contact with carbon dioxide and the like, allowed to stand for 3 days, and then filtered to obtain a potassium hydroxide solution.

The obtained potassium hydroxide solution is stored in an alkali-resistant container. The factor of the potassium hydroxide solution is obtained by placing 25 mL of 0.1 mol/L hydrochloric acid in an Erlenmeyer flask, adding a few drops of the phenolphthalein solution, titrating with the potassium hydroxide solution, and determining the amount of potassium hydroxide solution required for neutralization. The 0.1 mol/L hydrochloric acid used is prepared in accordance with JIS K 8001-1998.
(2) Procedure

### (A) Main Test

A total of 2.0 g of a sample (for example, the crystalline vinyl resin) is weighed out into a 200 mL Erlenmeyer flask, 100 mL of a toluene/ethanol (2:1) mixed solution is added, and dissolution is performed for 5 h.

Then, a few drops of the phenolphthalein solution is added as an indicator, and titration is performed using the potassium hydroxide solution. The end point of the titration is when the light red color of the indicator continues for 30 sec.

### (B) Blank Test

The titration is performed in the same manner as above, except that no sample is used (i.e., only a toluene/ethanol (2:1) mixed solution is used).
(3) The obtained results are substituted into the following formula to calculate the acid value.

$$A = [ ( C - B ) \times f \times 5.61 ] / S$$

Here, A is the acid value (mg KOH/g), B is the amount of potassium hydroxide solution added in the blank test (mL), C is the amount of potassium hydroxide solution added in the main test (mL), f is the factor of the potassium hydroxide solution, and S is the mass of the sample (g).

### EXAMPLES

The present invention will be described in more detail hereinbelow with reference to Examples, but the present invention is not limited thereto. Unless otherwise specified, the parts used in the following are based on mass.

### Preparation of Polymerizable Monomer (a-1)

A total of 727.3 parts of cetanol, 174.1 parts of fumaric acid, 2.5 parts of dibutyltin oxide, and 1 part of 2,6-di-tert-butyl-p-cresol were added to a pressurized reaction vessel equipped with a stirrer, a temperature controller, a thermometer, an air introducing tube, a pressure reducing device, and a water reducer, and the components were homogenized by stirring at 120° C. After that, the temperature was raised to 165° C., and the mixture was esterified under reduced pressure at 21 kPa for 3 h while removing distilled water. After confirming that the acid value was less than 30 mg KOH/g, the mixture was esterified under reduced pressure at 3 kPa or less for 12 h while removing distilled water. The esterification product was taken out to obtain a polymerizable monomer (a-1).

### Preparation of Polymerizable Monomers (a-2) to (a-12)

Polymerizable monomers (a-2) to (a-12) were produced in the same manner as in the preparation example of the polymerizable monomer (a-1), except that the types of raw materials and the amounts added were changed as shown in Table 1.

The compositions of polymerizable monomers (a-2) to (a-12) are shown in Table 1.

TABLE 1

| | Unsaturated | | | | | | | |
|---|---|---|---|---|---|---|---|---|
| Polymer- | polyvalent carboxylic acid | | Long-chain alcohol | | | | | |
| izable | | Number | | Number | Structure of monomer unit (a) | | | |
| monomer a | Type | of parts | Type | of parts | R¹ | R² | R³ | R⁴ |
| (a-1) | Fumaric acid | 175.0 | Cetanol | 727.0 | —COOC₁₆H₃₃ | H | H | —COOC₁₆H₃₃ |
| (a-2) | Fumaric acid | 175.0 | Stearyl alcohol | 811.0 | —COOC₁₈H₃₇ | H | H | —COOC₁₈H₃₇ |
| (a-3) | Fumaric acid | 175.0 | Behenyl alcohol | 979.0 | —COOC₂₂H₄₅ | H | H | —COOC₂₂H₄₅ |
| (a-4) | Fumaric acid | 175.0 | Octacosanol | 1232.0 | —COOC₂₈H₅₇ | H | H | —COOC₂₈H₅₇ |
| (a-5) | Fumaric acid | 175.0 | Myristyl alcohol | 1316.0 | —COOC₃₀H₆₁ | H | H | —COOC₃₀H₆₁ |
| (a-6) | Maleic acid | 175.0 | Behenyl alcohol | 979.0 | —COOC₂₂H₄₅ | H | —COOC₂₂H₄₅ | H |
| (a-7) | Citraconic acid | 196.0 | Behenyl alcohol | 979.0 | —COOC₂₂H₄₅ | CH₃ | —COOC₂₂H₄₅ | H |
| (a-8) | Itaconic acid | 196.0 | Behenyl alcohol | 979.0 | —COOC₂₂H₄₅ | —(CH₂)—COOC₂₂H₄₅ | H | H |
| (a-9) | trans-Aconitic acid | 175.0 | Behenyl alcohol | 979.0 | —COOC₂₂H₄₅ | —(CH₂)—COOC₂₂H₄₅ | H | —COOC₂₂H₄₅ |
| (a-10) | Fumaric acid | 178.0 | Behenyl alcohol | 978.0 | —COOC₂₂H₄₅ | H | H | —COOC₂₂H₄₅ |
| (a-11) | Fumaric acid | 182.5 | Behenyl alcohol | 978.0 | —COOC₂₂H₄₅ | H | H | —COOC₂₂H₄₅ |
| (a-12) | Fumaric acid | 175.0 | Lauryl alcohol | 559.0 | —COOC₁₂H₂₅ | H | H | —COOC₁₂H₂₅ |

### Preparation of Crystalline Vinyl Resin (A-1)

A total of 120.0 parts of xylene and 80.0 parts of the polymerizable monomer (a-1) were charged into an autoclave, and the temperature was raised to 135° C. while stirring in a sealed state, and then the pressure was released. Thereafter, the temperature was raised to 155° C. while stirring in a sealed state. A mixed solution of 14.0 parts of methacrylonitrile, 6.0 parts of styrene, 1.6 parts of di-t-butyl peroxide, and 60.0 parts of xylene was dropwise added over 3 h while controlling the temperature inside the autoclave to 155° C., and polymerization was carried out.

After dropwise addition, the dropping line was washed with 20.0 parts of xylene. After holding at the same temperature for another 2.2 h and then cooling to 70° C., 12.8 parts of di-t-butyl peroxide was added and reacted. The solvent was then removed at 170° C. for 3 h under reduced pressure of 0.5 to 2.5 kPa to obtain a crystalline vinyl resin (A-1). It was confirmed that the crystalline vinyl resin (A-1) is a crystalline resin that shows a clear endothermic peak in differential scanning calorimetry (DSC) measurements.

### Preparation of Crystalline Vinyl Resins (A-2) to (A-23)

Crystalline vinyl resins (A-2) to (A-23) were produced in the same manner as the crystalline vinyl resin (A-1), except that the types and amounts of raw materials added were changed as shown in Table 2. It was confirmed that the crystalline vinyl resins (A-2) to (A-23) are crystalline resins that show a clear endothermic peak in differential scanning calorimetry (DSC) measurements.

The compositions and physical properties of the crystalline vinyl resins (A-2) to (A-23) are shown in Table 2.

TABLE 2

| | First | | Second | | Third | | Fourth | | | | | |
|---|---|---|---|---|---|---|---|---|---|---|---|---|
| Crystalline | polymerizable | | polymerizable | | polymerizable | | polymerizable | | | | | |
| vinyl | monomer | | monomer | | monomer | | monomer | | Ratio J | Ratio K | Acid | |
| resin | | Number | | Number | | Number | | Number | (% by | (% by | value | ΔSP |
| No. | Type | of parts | Type | of parts | Type | of parts | Type | of parts | mass) | mass) | (mgKOH/g) | (J/m³)^{0.5} |
| A-1 | a-1 | 80.0 | Methacrylonitrile | 14.0 | Styrene | 6.0 | None | — | 80.0 | 100.0 | 0.9 | 7.4 |
| A-2 | a-2 | 80.0 | Methacrylonitrile | 14.0 | Styrene | 6.0 | None | — | 80.0 | 100.0 | 0.8 | 7.5 |
| A-3 | a-3 | 80.0 | Methacrylonitrile | 14.0 | Styrene | 6.0 | None | — | 80.0 | 100.0 | 0.7 | 7.7 |
| A-4 | a-4 | 80.0 | Methacrylonitrile | 14.0 | Styrene | 6.0 | None | — | 80.0 | 100.0 | 0.5 | 7.8 |
| A-5 | a-5 | 80.0 | Methacrylonitrile | 14.0 | Styrene | 6.0 | None | — | 80.0 | 100.0 | 0.5 | 7.9 |
| A-6 | a-6 | 80.0 | Methacrylonitrile | 14.0 | Styrene | 6.0 | None | — | 80.0 | 100.0 | 0.7 | 7.7 |
| A-7 | a-7 | 80.0 | Methacrylonitrile | 14.0 | Styrene | 6.0 | None | — | 80.0 | 100.0 | 0.6 | 7.8 |
| A-8 | a-8 | 80.0 | Methacrylonitrile | 14.0 | Styrene | 6.0 | None | — | 80.0 | 100.0 | 0.6 | 7.7 |
| A-9 | a-9 | 80.0 | Methacrylonitrile | 14.0 | Styrene | 6.0 | None | — | 80.0 | 100.0 | 0.7 | 7.7 |
| A-10 | a-3 | 45.0 | Methacrylonitrile | 14.0 | Styrene | 41.0 | None | — | 45.0 | 100.0 | 0.4 | 7.7 |
| A-11 | a-3 | 30.0 | Methacrylonitrile | 14.0 | Styrene | 56.0 | None | — | 30.0 | 100.0 | 0.3 | 7.7 |
| A-12 | a-3 | 20.0 | Methacrylonitrile | 14.0 | Styrene | 66.0 | None | — | 20.0 | 100.0 | 0.2 | 7.7 |
| A-13 | a-3 | 5.5 | Methacrylonitrile | 14.0 | Styrene | 80.5 | None | — | 5.5 | 100.0 | 0.1 | 7.7 |
| A-14 | a-3 | 4.0 | Methacrylonitrile | 14.0 | Styrene | 82.0 | None | — | 4.0 | 100.0 | 0.1 | 7.7 |
| A-15 | a-3 | 64.0 | Methacrylonitrile | 14.0 | Styrene | 6.0 | Behenyl acrylate | 16.0 | 64.0 | 80.0 | 0.6 | 7.7 |
| A-16 | a-3 | 40.0 | Methacrylonitrile | 14.0 | Styrene | 6.0 | Behenyl acrylate | 40.0 | 40.0 | 50.0 | 0.4 | 7.7 |
| A-17 | a-3 | 24.0 | Methacrylonitrile | 14.0 | Styrene | 6.0 | Behenyl acrylate | 56.0 | 24.0 | 30.0 | 0.2 | 7.7 |
| A-18 | a-10 | 80.0 | Methacrylonitrile | 14.0 | Styrene | 6.0 | None | — | 80.0 | 100.0 | 3.0 | 7.7 |
| A-19 | a-11 | 80.0 | Methacrylonitrile | 14.0 | Styrene | 6.0 | None | — | 80.0 | 100.0 | 6.1 | 7.7 |
| A-20 | a-3 | 80.0 | Styrene | 20.0 | None | — | None | — | 80.0 | 100.0 | 0.7 | 1.8 |
| A-21 | a-3 | 80.0 | Acrylamide | 14.0 | Styrene | 6.0 | None | — | 80.0 | 100.0 | 0.7 | 21.0 |
| A-22 | a-3 | 80.0 | Methyl acrylate | 14.0 | Styrene | 6.0 | None | — | 80.0 | 100.0 | 0.7 | 3.3 |
| A-23 | a-3 | 80.0 | Acrylonitrile | 14.0 | Styrene | 6.0 | None | — | 80.0 | 100.0 | 0.7 | 11.2 |
| A-24 | a-12 | 80.0 | Methacrylonitrile | 14.0 | Styrene | 6.0 | None | — | — | — | 1.0 | 7.1 |
| A-25 | None | — | Methacrylonitrile | 14.0 | Styrene | 20.0 | Behenyl acrylate | 80.0 | — | — | 1.0 | — |

In the table, the ratio J indicates the content ratio of monomer unit (a) based on the mass of the crystalline vinyl resin.

The ratio K indicates the content ratio of monomer unit (a) among monomer units having an alkyl group with 16 to 30 carbon atoms, including the monomer unit (a).

in the crystalline vinyl resin.

ΔSP indicates the value of |SPb−SPa|.

### Example 1

### Production of Toner by Suspension Polymerization Method

### Production of Toner Particles 1

| | |
|---|---|
| n-Butyl acrylate | 16.2 parts |
| Styrene | 48.8 parts |
| Colorant: Pigment Blue 15:3 | 6.5 parts |

A mixture of the above materials was prepared. The mixture was placed in an attritor (manufactured by Nippon Coke Corporation) and dispersed for 2 h at 200 rpm using zirconia beads with a diameter of 5 mm to obtain a raw material dispersion liquid.

Meanwhile, 735.0 parts of ion-exchanged water and 16.0 parts of trisodium phosphate (12-hydrate) were added to a container equipped with a high-speed stirring device Homomixer (manufactured by Primix Corporation) and a thermometer, and the temperature was raised to 60° C. while stirring at 12,000 rpm. An aqueous calcium chloride solution prepared by dissolving 9.0 parts of calcium chloride (dihydrate) in 65.0 parts of ion-exchanged water was added thereto, and stirring was carried out at 12,000 rpm for 30 min while maintaining the temperature at 60° C. Then, 10% hydrochloric acid was added thereto to adjust the pH to 6.0, yielding an aqueous medium in which an inorganic dispersion stabilizer containing hydroxyapatite was dispersed in water.

The raw material dispersion liquid was then transferred to a container equipped with a stirrer and a thermometer, and the temperature was raised to 60° C. while stirring at 100 rpm.

| | |
|---|---|
| Crystalline vinyl resin (A-1) | 35.0 parts |
| Release agent (DP18) | 9.0 parts |

DP18 (dipentaerythritol stearate wax, melting point 79° C., manufactured by Nisshin Oillio Co., Ltd.)

The above materials were added and stirred at 100 rpm for 30 min while keeping the temperature at 60° C., after which 5.0 parts of t-butyl peroxypivalate (manufactured by NOF Corp.: Perbutyl PV) was added as a polymerization initiator and then stirring was performed for another minute. The mixture was then charged into the aqueous medium being stirred at 12,000 rpm with the high-speed stirring device. Stirring was continued for 20 min at 12,000 rpm with the high-speed stirring device while keeping the temperature at 60° C., and a granulation liquid was obtained.

The granulation liquid was transferred to a reaction vessel equipped with a reflux condenser, a stirrer, a thermometer, and a nitrogen introducing tube, and heated to 70° C. while stirring at 150 rpm under a nitrogen atmosphere. The polymerization reaction was carried out at 150 rpm for 12 h while keeping the temperature at 70° C. to obtain a toner particle dispersion liquid.

The toner particle dispersion liquid obtained was cooled to 45° C. while stirring at 150 rpm, and then heat-treated for 5 hours while keeping the temperature at 45° C. Dilute hydrochloric acid was then added while maintaining stirring until the pH reached 1.5 to dissolve the dispersion stabilizer. The solid fraction was filtered off, thoroughly washed with ion-exchanged water, and then vacuum-dried at 30° C. for 24 h to obtain toner particle 1.

### Preparation of Toner 1

A total of 2.0 parts of silica fine particles (hydrophobized with hexamethyldisilazane, number-average particle diameter of primary particles: 10 nm, BET specific surface area: 170 m²/g) were added, as an external additive, to the toner particle 1:98.0 parts, and mixing was performed for 15 min at 3000 rpm using a Henschel mixer (manufactured by Nippon Coke Corporation) to obtain toner 1. The obtained toner 1 was evaluated by the following method. The physical properties of the obtained toner 1 are shown in Tables 3-1 and 3-2, and the evaluation results are shown in Tables 4-1 and 4-2.

TABLE 3-1

| | | Binder resin | | | | | | | | |
|---|---|---|---|---|---|---|---|---|---|---|
| | | | | Amorphous vinyl resin B | | | | | | |
| | | Crystalline | | Polymerizable | | Polymerizable | | | | Polymerization |
| | | vinyl resin A | | monomer b1 | | monomer b2 | | Crosslinking agent | | initiator |
| | | | Amount | | Amount | | Amount | | Amount | Amount |
| Example | Toner | | added | | added | | added | | added | added |
| No. | No. | No. | (parts) | Type | (parts) | Type | (parts) | Type | (parts) | (parts) |
| Example 1 | 1 | A-3 | 35.0 | St | 48.8 | BA | 16.2 | 1,6-Hexane diol diacrylate | 0.1 | 5.0 |
| Example 2 | 2 | A-3 | 35.0 | St | 48.8 | BA | 16.2 | 1,6-Hexane diol diacrylate | 0.3 | 5.0 |
| Example 3 | 3 | A-3 | 35.0 | St | 48.8 | BA | 16.2 | 1,6-Hexane diol diacrylate | 0.4 | 5.0 |
| Example 4 | 4 | A-3 | 35.0 | St | 48.8 | BA | 16.2 | 1,6-Hexane diol diacrylate | 0.7 | 5.0 |
| Example 5 | 5 | A-3 | 35.0 | St | 48.8 | BA | 16.2 | 1,6-Hexane diol diacrylate | 0.9 | 5.0 |
| Example 6 | 6 | A-3 | 35.0 | St | 48.8 | BA | 16.2 | 1,6-Hexane diol diacrylate | 1.0 | 5.0 |
| Example 7 | 7 | A-3 | 35.0 | St | 48.8 | BA | 16.2 | 1,6-Hexane diol diacrylate | 1.1 | 5.0 |
| Example 8 | 8 | A-3 | 35.0 | St | 48.8 | BA | 16.2 | 1,6-Hexane diol diacrylate | 1.2 | 5.0 |
| Example 9 | 9 | A-3 | 90.0 | St | 7.5 | BA | 2.5 | 1,6-Hexane diol diacrylate | 0.1 | 5.0 |
| Example 10 | 10 | A-3 | 80.0 | St | 15.0 | BA | 5.0 | 1,6-Hexane diol diacrylate | 0.2 | 5.0 |
| Example 11 | 11 | A-3 | 55.0 | St | 33.8 | BA | 11.2 | 1,6-Hexane diol diacrylate | 0.6 | 5.0 |
| Example 12 | 12 | A-3 | 28.0 | St | 54.1 | BA | 17.9 | 1,6-Hexane diol diacrylate | 0.8 | 5.0 |
| Example 13 | 13 | A-3 | 21.0 | St | 60.1 | BA | 19.9 | 1,6-Hexane diol diacrylate | 0.8 | 5.0 |
| Example 14 | 14 | A-3 | 10.0 | St | 67.6 | BA | 22.4 | 1,6-Hexane diol diacrylate | 1.0 | 5.0 |
| Example 15 | 15 | A-3 | 35.0 | St | 48.8 | BA | 16.2 | Divinylbenzene | 0.7 | 5.0 |
| Example 16 | 16 | A-3 | 35.0 | St | 48.8 | BA | 16.2 | None | 0.0 | 1.0 |
| Example 17 | 17 | A-1 | 35.0 | St | 48.8 | BA | 16.2 | 1,6-Hexane diol diacrylate | 0.7 | 5.0 |
| Example 18 | 18 | A-2 | 35.0 | St | 48.8 | BA | 16.2 | 1,6-Hexane diol diacrylate | 0.7 | 5.0 |
| Example 19 | 19 | A-4 | 35.0 | St | 48.8 | BA | 16.2 | 1,6-Hexane diol diacrylate | 0.7 | 5.0 |
| Example 20 | 20 | A-5 | 35.0 | St | 48.8 | BA | 16.2 | 1,6-Hexane diol diacrylate | 0.7 | 5.0 |
| Example 21 | 21 | A-6 | 35.0 | St | 48.8 | BA | 16.2 | 1,6-Hexane diol diacrylate | 0.7 | 5.0 |
| Example 22 | 22 | A-7 | 35.0 | St | 48.8 | BA | 16.2 | 1,6-Hexane diol diacrylate | 0.7 | 5.0 |
| Example 23 | 23 | A-8 | 35.0 | St | 48.8 | BA | 16.2 | 1,6-Hexane diol diacrylate | 0.7 | 5.0 |
| Example 24 | 24 | A-9 | 35.0 | St | 48.8 | BA | 16.2 | 1,6-Hexane diol diacrylate | 0.7 | 5.0 |
| Example 25 | 25 | A-10 | 35.0 | St | 48.8 | BA | 16.2 | 1,6-Hexane diol diacrylate | 0.7 | 5.0 |
| Example 26 | 26 | A-11 | 35.0 | St | 48.8 | BA | 16.2 | 1,6-Hexane diol diacrylate | 0.7 | 5.0 |
| Example 27 | 27 | A-12 | 35.0 | St | 48.8 | BA | 16.2 | 1,6-Hexane diol diacrylate | 0.7 | 5.0 |
| Example 28 | 28 | A-13 | 35.0 | St | 48.8 | BA | 16.2 | 1,6-Hexane diol diacrylate | 0.7 | 5.0 |
| Example 29 | 29 | A-15 | 35.0 | St | 48.8 | BA | 16.2 | 1,6-Hexane diol diacrylate | 0.7 | 5.0 |
| Example 30 | 30 | A-16 | 35.0 | St | 48.8 | BA | 16.2 | 1,6-Hexane diol diacrylate | 0.7 | 5.0 |
| Example 31 | 31 | A-17 | 35.0 | St | 48.8 | BA | 16.2 | 1,6-Hexane diol diacrylate | 0.7 | 5.0 |
| Example 32 | 32 | A-18 | 35.0 | St | 48.8 | BA | 16.2 | 1,6-Hexane diol diacrylate | 0.7 | 5.0 |
| Example 33 | 33 | A-19 | 35.0 | St | 48.8 | BA | 16.2 | 1,6-Hexane diol diacrylate | 0.7 | 5.0 |
| Example 34 | 34 | A-20 | 35.0 | St | 48.8 | BA | 16.2 | 1,6-Hexane diol diacrylate | 0.7 | 5.0 |
| Example 35 | 35 | A-21 | 35.0 | St | 48.8 | BA | 16.2 | 1,6-Hexane diol diacrylate | 0.7 | 5.0 |
| Example 36 | 36 | A-22 | 35.0 | St | 48.8 | BA | 16.2 | 1,6-Hexane diol diacrylate | 0.7 | 5.0 |
| Example 37 | 37 | A-23 | 35.0 | St | 48.8 | BA | 16.2 | 1,6-Hexane diol diacrylate | 0.7 | 5.0 |
| Comparative | 38 | A-24 | 35.0 | St | 48.8 | BA | 16.2 | 1,6-Hexane diol diacrylate | 0.7 | 5.0 |
| Example 1 | | | | | | | | | | |
| Comparative | 39 | A-25 | 35.0 | St | 48.8 | BA | 16.2 | 1,6-Hexane diol diacrylate | 0.7 | 5.0 |
| Example 2 | | | | | | | | | | |
| Comparative | 40 | A.14 | 35.0 | St | 48.8 | BA | 16.2 | 1,6-Hexane diol diacrylate | 0.7 | 5.0 |
| Example 3 | | | | | | | | | | |
| Comparative | 41 | None | — | St | 75.0 | BA | 25. | 1,6-Hexane diol diacrylate | 0.7 | 5.0 |
| Example 4 | | | | | | | | | | |
| Comparative | 42 | A-3 | 35.0 | St | 48.8 | BA | 16.2 | None | — | 5.0 |
| Example 5 | | | | | | | | | | |

TABLE 3-2

| | Toner | Ratio I | Ratio L | Ratio M |
|---|---|---|---|---|
| Example No. | No. | (% by mass) | (% by mass) | (% by mass) |
| Example 1 | 1 | 35.0 | 2.0 | 5.7 |
| Example 2 | 2 | 34.9 | 5.0 | 14.3 |
| Example 3 | 3 | 34.9 | 6.5 | 18.6 |
| Example 4 | 4 | 34.8 | 20.0 | 57.1 |
| Example 5 | 5 | 34.7 | 30.0 | 85.7 |
| Example 6 | 6 | 34.7 | 40.0 | 114.3 |
| Example 7 | 7 | 34.6 | 50.0 | 142.9 |
| Example 8 | 8 | 34.6 | 54.0 | 154.3 |
| Example 9 | 9 | 89.9 | 20.0 | 22.2 |
| Example 10 | 10 | 79.8 | 20.0 | 25.0 |
| Example 11 | 11 | 54.7 | 20.0 | 36.4 |
| Example 12 | 12 | 27.8 | 20.0 | 71.4 |
| Example 13 | 13 | 20.6 | 20.0 | 95.2 |
| Example 14 | 14 | 9.9 | 20.0 | 200.0 |
| Example 15 | 15 | 34.8 | 20.0 | 57.1 |
| Example 16 | 16 | 35.0 | 5.0 | 14.3 |
| Example 17 | 17 | 34.8 | 20.0 | 57.1 |
| Example 18 | 18 | 34.8 | 20.0 | 57.1 |
| Example 19 | 19 | 34.8 | 20.0 | 57.1 |
| Example 20 | 20 | 34.8 | 20.0 | 57.1 |
| Example 21 | 21 | 34.8 | 20.0 | 57.1 |
| Example 22 | 22 | 34.8 | 20.0 | 57.1 |
| Example 23 | 23 | 34.8 | 20.0 | 57.1 |
| Example 24 | 24 | 34.8 | 20.0 | 57.1 |
| Example 25 | 25 | 34.8 | 20.0 | 57.1 |
| Example 26 | 26 | 34.8 | 20.0 | 57.1 |
| Example 27 | 27 | 34.8 | 20.0 | 57.1 |
| Example 28 | 28 | 34.8 | 20.0 | 57.1 |
| Example 29 | 29 | 34.8 | 20.0 | 57.1 |
| Example 30 | 30 | 34.8 | 20.0 | 57.1 |
| Example 31 | 31 | 34.8 | 20.0 | 57.1 |
| Example 32 | 32 | 34.8 | 20.0 | 57.1 |
| Example 33 | 33 | 34.8 | 20.0 | 57.1 |
| Example 34 | 34 | 34.8 | 20.0 | 57.1 |
| Example 35 | 35 | 34.8 | 20.0 | 57.1 |
| Example 36 | 36 | 34.8 | 20.0 | 57.1 |
| Example 37 | 37 | 34.8 | 20.0 | 57.1 |
| Comparative | 38 | 34.8 | 20.0 | 57.1 |
| Example 1 | | | | |
| Comparative | 39 | 34.8 | 20.0 | 57.1 |
| Example 2 | | | | |
| Comparative | 40 | 34.8 | 20.0 | 57.1 |
| Example 3 | | | | |
| Comparative | 41 | — | 30.8 | — |
| Example 4 | | | | |
| Comparative | 42 | 35.0 | 0.0 | 0.0 |
| Example 5 | | | | |

In the table, St represents styrene and BA represents n-butyl acrylate.

The ratio I represents the content ratio of the crystalline vinyl resin based on the mass of the binder resin.

The ratio L represents the content ratio of the THF insoluble matter based on the mass of the binder resin.

The ratio M represents the content ratio of the THF insoluble matter based on the mass of the crystalline vinyl resin.

TABLE 4-1

| | | Physical properties of crystalline vinyl resin | | | | Physical properties of toner particle | | |
|---|---|---|---|---|---|---|---|---|
| Example | Toner | Ratio J | Ratio K | Acid value | ΔSP | Ratio I | Ratio L | Ratio M |
| No. | No. | (% by mass) | (% by mass) | (mgKOH/g) | (J/m³)^{0.5} | (% by mass) | (% by mass) | (% by mass) |
| Example 1 | 1 | 80.0 | 100.0 | 0.7 | 7.7 | 35.0 | 2.0 | 5.7 |
| Example 2 | 2 | 80.0 | 100.0 | 0.7 | 7.7 | 34.9 | 5.0 | 14.3 |
| Example 3 | 3 | 80.0 | 100.0 | 0.7 | 7.7 | 34.9 | 6.5 | 18.6 |
| Example 4 | 4 | 80.0 | 100.0 | 0.7 | 7.7 | 34.8 | 20.0 | 57.1 |
| Example 5 | 5 | 80.0 | 100.0 | 0.7 | 7.7 | 34.7 | 30.0 | 85.7 |
| Example 6 | 6 | 80.0 | 100.0 | 0.7 | 7.7 | 34.7 | 40.0 | 114.3 |
| Example 7 | 7 | 80.0 | 100.0 | 0.7 | 7.7 | 34.6 | 50.0 | 142.9 |
| Example 8 | 8 | 80.0 | 100.0 | 0.7 | 7.7 | 34.6 | 54.0 | 154.3 |
| Example 9 | 9 | 80.0 | 100.0 | 0.7 | 7.7 | 89.9 | 20.0 | 22.2 |
| Example 10 | 10 | 80.0 | 100.0 | 0.7 | 7.7 | 79.8 | 20.0 | 25.0 |
| Example 11 | 11 | 80.0 | 100.0 | 0.7 | 7.7 | 54.7 | 20.0 | 36.4 |
| Example 12 | 12 | 80.0 | 100.0 | 0.7 | 7.7 | 27.8 | 20.0 | 71.4 |
| Example 13 | 13 | 80.0 | 100.0 | 0.7 | 7.7 | 20.6 | 20.0 | 95.2 |
| Example 14 | 14 | 80.0 | 100.0 | 0.7 | 7.7 | 9.9 | 20.0 | 200.0 |
| Example 15 | 15 | 80.0 | 100.0 | 0.7 | 7.7 | 34.8 | 20.0 | 57.1 |
| Example 16 | 16 | 80.0 | 100.0 | 0.7 | 7.7 | 35.0 | 5.0 | 14.3 |
| Example 17 | 17 | 80.0 | 100.0 | 0.9 | 7.4 | 34.8 | 20.0 | 57.1 |
| Example 18 | 18 | 80.0 | 100.0 | 0.8 | 7.5 | 34.8 | 20.0 | 57.1 |
| Example 19 | 19 | 80.0 | 100.0 | 0.5 | 7.8 | 34.8 | 20.0 | 57.1 |
| Example 20 | 20 | 80.0 | 100.0 | 0.5 | 7.9 | 34.8 | 20.0 | 57.1 |
| Example 21 | 21 | 80.0 | 100.0 | 0.7 | 7.7 | 34.8 | 20.0 | 57.1 |
| Example 22 | 22 | 80.0 | 100.0 | 0.6 | 7.8 | 34.8 | 20.0 | 57.1 |
| Example 23 | 23 | 80.0 | 100.0 | 0.6 | 7.7 | 34.8 | 20.0 | 57.1 |
| Example 24 | 24 | 80.0 | 100.0 | 0.7 | 7.7 | 34.8 | 20.0 | 57.1 |
| Example 25 | 25 | 45.0 | 100.0 | 0.4 | 7.7 | 34.8 | 20.0 | 57.1 |
| Example 26 | 26 | 30.0 | 100.0 | 0.3 | 7.7 | 34.8 | 20.0 | 57.1 |
| Example 27 | 27 | 20.0 | 100.0 | 0.2 | 7.7 | 34.8 | 20.0 | 57.1 |
| Example 28 | 28 | 5.5 | 100.0 | 0.1 | 7.7 | 34.8 | 20.0 | 57.1 |
| Example 29 | 29 | 64.0 | 80.0 | 0.6 | 7.7 | 34.8 | 20.0 | 57.1 |
| Example 30 | 30 | 40.0 | 50.0 | 0.4 | 7.7 | 34.8 | 20.0 | 57.1 |
| Example 31 | 31 | 24.0 | 30.0 | 0.2 | 7.7 | 34.8 | 20.0 | 57.1 |
| Example 32 | 32 | 80.0 | 100.0 | 3.0 | 7.7 | 34.8 | 20.0 | 57.1 |
| Example 33 | 33 | 80.0 | 100.0 | 6.1 | 7.7 | 34.8 | 20.0 | 57.1 |
| Example 34 | 34 | 80.0 | 100.0 | 0.7 | 1.8 | 34.8 | 20.0 | 57.1 |
| Example 35 | 35 | 80.0 | 100.0 | 0.7 | 21.0 | 34.8 | 20.0 | 57.1 |
| Example 36 | 36 | 80.0 | 100.0 | 0.7 | 3.3 | 34.8 | 20.0 | 57.1 |
| Example 37 | 37 | 80.0 | 100.0 | 0.7 | 11.2 | 34.8 | 20.0 | 57. |
| Comparative | 38 | — | — | 1.0 | 7.1 | 34.8 | 20.0 | 57.1 |
| Example 1 | | | | | | | | |
| Comparative | 39 | — | — | 1.0 | — | 34.8 | 20.0 | 57.1 |
| Example 2 | | | | | | | | |
| Comparative | 40 | 4.0 | 100.0 | 0.1 | 7.7 | 34.8 | 20.0 | 57.1 |
| Example 3 | | | | | | | | |
| Comparative | 41 | — | — | — | — | — | 30.8 | — |
| Example 4 | | | | | | | | |
| Comparative | 42 | 80.0 | 100.0 | 0.0 | 7.7 | 35.0 | 0.0 | 0.0 |
| Example 5 | | | | | | | | |

TABLE 4-2

| | | Evaluation results | | |
|---|---|---|---|---|
| | | Evaluation 1 | | |
| | | Low-temperature | | |
| | | fixability | Evaluation 2 | Evaluation 3 |
| | | Fixing start | Durability | Change in |
| | Toner | temperature | evaluation | gloss after |
| Example No. | No. | (° C.) | rank | storage (ΔG) |
| Example 1 | 1 | 90.0 | C | 9.6 |
| Example 2 | 2 | 90.0 | B | 8.7 |
| Example 3 | 3 | 95.0 | B | 5.1 |
| Example 4 | 4 | 95.0 | A | 1.0 |
| Example 5 | 5 | 100.0 | A | 3.2 |
| Example 6 | 6 | 110.0 | A | 7.7 |
| Example 7 | 7 | 110.0 | A | 8.7 |
| Example 8 | 8 | 115.0 | A | 9.6 |
| Example 9 | 9 | 100.0 | A | 7.7 |
| Example 10 | 10 | 95.0 | A | 6.4 |
| Example 11 | 11 | 95.0 | A | 5.1 |
| Example 12 | 12 | 100.0 | A | 5.1 |
| Example 13 | 13 | 105.0 | A | 7.5 |
| Example 14 | 14 | 115.0 | A | 9.6 |
| Example 15 | 15 | 95.0 | A | 3.2 |
| Example 16 | 16 | 90.0 | C | 11.2 |
| Example 17 | 17 | 100.0 | A | 3.2 |
| Example 18 | 18 | 100.0 | A | 1.0 |
| Example 19 | 19 | 105.0 | A | 3.2 |
| Example 20 | 20 | 105.0 | A | 3.2 |
| Example 21 | 21 | 100.0 | A | 3.2 |
| Example 22 | 22 | 105.0 | A | 3.2 |
| Example 23 | 23 | 105.0 | A | 3.2 |
| Example 24 | 24 | 100.0 | A | 3.2 |
| Example 25 | 25 | 105.0 | A | 5.1 |
| Example 26 | 26 | 110.0 | A | 6.4 |
| Example 27 | 27 | 115.0 | A | 7.7 |
| Example 28 | 28 | 115.0 | A | 8.7 |
| Example 29 | 29 | 95.0 | A | 6.8 |
| Example 30 | 30 | 95.0 | A | 7.8 |
| Example 31 | 31 | 95.0 | A | 10.6 |
| Example 32 | 32 | 105.0 | A | 6.4 |
| Example 33 | 33 | 110.0 | A | 7.7 |
| Example 34 | 34 | 110.0 | A | 7.7 |
| Example 35 | 35 | 100.0 | A | 5.1 |
| Example 36 | 36 | 100.0 | A | 5.1 |
| Example 37 | 37 | 95.0 | A | 3.2 |
| Comparative | 38 | 105.0 | A | 16.0 |
| Example 1 | | | | |
| Comparative | 39 | 95.0 | A | 18.0 |
| Example 2 | | | | |
| Comparative | 40 | 125.0 | A | 8.8 |
| Example 3 | | | | |
| Comparative | 41 | 130.0 | A | 0.8 |
| Example 4 | | | | |
| Comparative | 42 | 90.0 | D | 1.5 |
| Example 5 | | | | |

### Examples 2 to 37

Toner particles 2 to 37 were obtained in the same manner as in Example 1, except that the types and amounts of polymerizable monomers used, the type and amount of crosslinking agent, and the amount of polymerization initiator added were changed as shown in Table 3-1.

Furthermore, external addition was performed in the same manner as in Example 1 to obtain toners 2 to 37, which were evaluated as Examples 2 to 37. The physical properties of the toners in Examples 2 to 37 are shown in Table 3-2, and the evaluation results are shown in Tables 4-1 and 4-2.

### Comparative Examples 1 to 5

Comparative toner particles 38 to 42 were obtained in the same manner as in Example 1, except that the types and amounts of polymerizable monomers used, the type and amount of crosslinking agent, and the amount of polymerization initiator added were changed as shown in Table 3-1.

Furthermore, external addition was performed in the same manner as in Example 1 to obtain comparative toners 38 to 42, which were evaluated as Comparative Examples 1 to 5. The physical properties of the toners in Comparative Examples 1 to 5 are shown in Table 3-2, and the evaluation results are shown in Tables 4-1 and 4-2.

When the obtained toners 2 to 42 were analyzed by the method described above, the values of ratio J and ratio K were obtained as in Table 2.

### Toner Evaluation Methods

### Evaluation 1 Low-Temperature Fixability

A process cartridge filled with the toner was allowed to stand at a temperature of 25° C. and a humidity of 40% RH for 48 h. An LBP-712Ci modified to enable operation even when the fixing unit was removed was used, and an unfixed image of an image pattern in which 10 mm×10 mm square images were evenly arranged in 9 points over the entire transfer paper was output. The toner laid-on level on the transfer paper was 0.80 mg/cm², and the fixing start temperature was evaluated. The transfer paper used was A4 paper (“Prover Bond Paper”: 105 g/m², manufactured by Fox River).

The fixing unit used was an external fixing unit that had been removed from the LBP-712Ci and was able to operate outside the laser beam printer. The fixing temperature of the external fixing unit was raised in 5° C. increments from 90° C., and fixing was performed under the condition of a process speed of 240 mm/sec.

The fixed image was visually checked, and the minimum temperature at which cold offset did not occur was evaluated as the fixing start temperature. The evaluation results are shown in Table 4-2.

### Evaluation 2 Durability

A commercial Canon printer LBP-712Ci was used to evaluate durability.

The cartridge for evaluation was obtained by removing the toner loaded in the commercial cartridge, cleaning the inside with an air blower, and then filling the cartridge with 200 g of the toner for evaluation.

The cartridge was installed in the cyan station, and dummy cartridges were installed in the other stations to perform evaluation.

In a normal temperature and humidity (N/N) environment (23° C., 60% RH), Canon Oce Red Label (80 g/m²) was used as transfer paper, and 20,000 images with a print percentage of 1% were output continuously.

After outputting the 20,000 images, one solid image and one halftone image for evaluation were output, and the presence or absence of circumferential streaks caused by toner melting to the regulating member, so-called development stripes, was visually confirmed and evaluated according to the following criteria. The fact that the occurrence of development stripes is suppressed indicates that the toner does not deteriorate even after durability output and has excellent durability. The evaluation results are shown in Table 4-2.

### Evaluation Criteria

A: No development stripes
B: Development stripes occur in 1 or 2 places
C: Development stripes occur in 3 or 4 places
D: Development stripes occur in 5 places or more

### Evaluation 3 Change in Gloss of Fixed Images After Storage

### Heat Cycle Test Simulating Cargo Ship Transportation

When shipping products by sea on cargo ships, in conditions where temperature and humidity are not controlled, such as in dry containers, the products are exposed to an environment with large temperature and humidity differences between day and night depending on the region and situation, so the following conditions were set.

For the heat cycle test, 100 g of the toner to be evaluated was placed in a 500 ml sampler (R) Polycap (manufactured by Sanplatec Co., Ltd.). Next, the Polycap containing the toner was placed in a thermohygrostat IX210 (manufactured by Yamato Scientific Co., Ltd.) and a heat cycle test simulating dry container cargo ship transportation was carried out. The specific conditions were as follows. First, holding at a temperature of 30° C. and 70% RH for 18 h, then changing to 50° C. temperature and 55% RH over 2 h and holding for 2 h, followed by changing to a temperature of 30° C. and 70% RH over 2 h. This heat cycle was repeated 20 times. The temperature and humidity changes are illustrated in the figure.

### Change in Gloss of Fixed Images

The toner before and after the above heat cycle test was filled into the respective process cartridge of LBP-712Ci and allowed to stand for 48 h at a temperature of 25° C. and a humidity of 40% RH. An image pattern in which 10 mm×10 mm square images were evenly arranged in 9 points over the entire transfer paper was output using LBP-712Ci. The toner laid-on level on the transfer paper was 0.80 mg/cm². The transfer paper used was A4 paper (“Prover Bond Paper”: 105 g/m², manufactured by Fox River). The fixing temperature was 40° C. higher than the fixing start temperature in the low-temperature fixing evaluation in <1> above.

The gloss value of the output fixed images was measured using a handy gloss meter PG-1 (manufactured by Nippon Denshoku Industries Co., Ltd.). The measurement conditions were set to 75° for the projection angle and reception angle, and the entire image pattern arranged in 9 points was measured and the average value was evaluated. The average gloss value of the fixed images before the heat cycle test was G0, the average gloss value of the fixed images after the heat cycle test was G1, and the gloss fluctuation ΔG was calculated using the following formula.

$$Δ G = \vert G 1 - G 0 \vert \qquad ( 9 )$$

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. This application claims the benefit of Japanese Patent Application No. 2023-210575, filed Dec. 13, 2023, which is hereby incorporated by reference herein in its entirety.

What is claimed is:

1. A toner comprising a toner particle comprising a binder resin, wherein
the binder resin comprises a crystalline vinyl resin and an amorphous vinyl resin,
the crystalline vinyl resin comprises 5.0% by mass or more of a monomer unit (a) represented by a following formula (1), based on a mass of the crystalline vinyl resin: 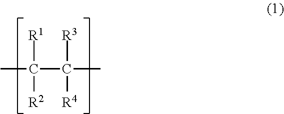
in the formula (1), at least two of R¹ to R⁴ are each independently —X—CO OR⁵, and the remaining are each independently a hydrogen atom or an alkyl group having 1 to 4 carbon atoms, X is a single bond or an alkylene group having 1 or 2 carbon atoms, and R⁵ is an alkyl group having 16 to 30 carbon atoms, and
the amorphous vinyl resin comprises a tetrahydrofuran insoluble matter.

2. The toner according to claim 1, wherein the binder resin comprises 20 to 80% by mass of the crystalline vinyl resin, based on the mass of the binder resin.

3. The toner according to claim 1, wherein the crystalline vinyl resin comprises 30.0% by mass or more of the monomer unit (a), based on the mass of the crystalline vinyl resin.

4. The toner according to claim 1, wherein in the crystalline vinyl resin, a content ratio of the monomer unit (a) among monomer units having an alkyl group with 16 to 30 carbon atoms, including the monomer unit (a), is 50.0 to 100.0% by mass.

5. The toner according to claim 1, wherein an acid value of the crystalline vinyl resin is 3.0 mg KOH/g or less.

6. The toner according to claim 1, wherein
the crystalline vinyl resin comprises, in addition to the monomer unit (a), a monomer unit (b) different from the monomer unit (a), and
where an SP value of the monomer unit (a) is SPa (J/cm³)^{0.5} and an SP value of the monomer unit (b) is SPb (J/cm³)^{0.5}, the SPa and the SPb satisfy a following formula (2):
$$3. 0 \leq \vert SPb - SPa \vert \leq 21. . \qquad ( 2 )$$

7. The toner according to claim 1, wherein the binder resin comprises 2.0 to 50.0% by mass of the tetrahydrofuran insoluble matter, based on the mass of the binder resin.

8. The toner according to claim 1, wherein the crystalline vinyl resin comprises 5.0 to 100.0% by mass of the tetrahydrofuran insoluble matter, based on the mass of the crystalline vinyl resin.

9. The toner according to claim 1, wherein
the amorphous vinyl resin is a polymer of a composition comprising a polymerizable monomer and a crosslinking agent, and
the crosslinking agent has two or more polymerizable double bonds.
